(19) United States
(12) Patent Application Publication
(10) Pub. No.: US 2013/0176907 A1
(43) Pub. Date: Jul. 11, 2013

(54) OFFLINE CHARGING OF M2M INTERACTIONS

(71) Applicant: George Foti, Dollard des Ormeaux (CA)

(72) Inventor: George Foti, Dollard des Ormeaux (CA)

(21) Appl. No.: 13/710,028

(22) Filed: Dec. 10, 2012

Related U.S. Application Data
(60) Provisional application No. 61/583,813, filed on Jan. 6, 2012.
(60) Provisional application No. 61/602,415, filed on Feb. 23, 2012.
(60) Provisional application No. 61/608,352, filed on Mar. 8, 2012.

(51) Int. Cl. H04L 12/14

(52) U.S. Cl. CPC H04L 12/1407
USPC 370/259

(57) ABSTRACT

An M2M CDF is used to allow the creation of charging records in an M2M domain that can be correlated to charging records in a transport domain. This correlation of data can be used to provide a network access provider with the ability to provide M2M based charging in a variety of scenarios using different network topologies.

### CROSS REFERENCE TO RELATED APPLICATIONS

This application claims the benefit of priority to the following U.S. Provisional Patent Applications, the contents of which are expressly incorporated herein: U.S. Provisional Patent Application No. 61/583,813 filed Jan. 6, 2012, U.S. Provisional Patent Application No. 61/602,415 filed Feb. 23, 2012 and U.S. Provisional Patent Application No. 61/608,352 filed Mar. 8, 2012.

### TECHNICAL FIELD

This disclosure relates generally to generating charging events for machine-to-machine transactions in a data network.

### BACKGROUND

Mobile data networks have typically arisen as overlays to cellular communication networks. As such, they often have many technical design features that arise as a result of maintaining compliance with legacy rules and standards. As mobile devices become more data-centric, some of these issued have become prominent. Addressing these issues is a delicate balance between solving issues in a technologically simple and straightforward manner and maintaining compatibility with existing systems.

At their inception, mobile data networks largely supported human operated devices, typically mobile phones and data cards used to connect laptops and other computing devices to the Internet. As a result, the vast majority of these connections were human controlled. As technology advances, and as the desire for a more connected world increases, there are an increasing number of devices using mobile data connections that are computer controlled and do not require human operation. These devices are typically referred to as machine-to-machine (M2M) devices, and or Machine Type Communication (MTC) devices.

M2M devices are often connected to sensors and meters to allow for a distributed collection of information without requiring human data collection. This often enables more granular data collection allowing for an increased variety of services and options to consumers.

One issue that has arisen is how a carrier will be able to generate charging events associated with the operation of M2M devices. In different deployment scenarios different techniques must be used to identify the proper events which result is charging events being generated. For example, if the M2M devices are connected through a cellular radio access network, and the radio access network provider is also the M2M service provider, the identification of the different charging events may be simpler than the scenario where the radio access network provider is being treated as a simple bit pipe (i.e. the radio access network provider simply provides data connectivity and has no business or other relationship to the M2M service provider that allows for additional information to be gathered).

The manner in which charging events are generated are of great interest, although one skilled in the art will appreciate that this is different from how the billing of actual events is handled, which is not germane to the present discussion.

Therefore, it would be desirable to provide a system and method that obviate or mitigate the above described problems

### SUMMARY

It is an object of the present invention to obviate or mitigate at least one disadvantage of the prior art.

In a first aspect of the present invention, there is provided a method of storing statistical usage information related to machine-to-machine (M2M) device usage of network resources, for execution by a node in a machine to machine network domain. The method comprises the steps of receiving an indication of an interaction associated with an M2M device; determining that the interaction is part of a charging event; recording information associated with the charging event in a data repository associated with an M2M network domain Network Service Control Layer (NSCL); and ensuring that information associated with the charging event is recorded by an a third party associated with the M2M device.

In an embodiment of the first aspect of the present invention, receiving the indication includes receiving notification of receipt of one of a message addressed to the M2M device and a message sent by the M2M device. In another embodiment, the charging event includes an event for which a subscriber account should be adjusted. In a further embodiment, the charging event includes an event for which statistical usage information should be recorded and for which a subscriber account should not be adjusted. In yet another embodiment, the third party is an access network is used by the M2M device for access to the M2M network domain. In a further embodiment, the step of ensuring that the charging event is recorded by the third party includes transmitting an instruction to record the event to a service control layer (SCL) in the access network. In another embodiment, the step of recording the charging event in the M2M network domain NSCL includes transmitting the charging event to a M2M network domain Charging Data Function (CDF). In another embodiment, the steps of ensuring that the charging event is recorded by the third party and recording the charging event in an M2M domain NSCL are performed by recording the charging event in a resource accessible to both an Access Network and the M2M NSCL. In a further embodiment, the steps of ensuring that the charging event is recorded by the third party and recording the charging event in an M2M domain NSCL are performed by transmitting instructions to a M2M network domain CDF to store information associated with the charging event and to forward information associated with the charging event to an access network associated with the M2M device, and optionally the instruction to the M2M CDF to forward information directs the M2M CDF to forward information to the access network CDF. In another embodiment, the step of ensuring includes transmitting an instruction to an access network SCL through the network traffic plane. In a further embodiment, the third party is a gateway connecting the M2M device to the M2M network domain and optionally, the step of ensuring the charging event is recorded by a third party includes requesting that the gateway store the charging information and the step of requesting can be done during registration of the gateway to the M2M network domain. In a further embodiment, the recorded information in the data repository associated with the NSCL and the information recorded by the third party is identical.

In a second aspect of the present invention, there is provided a machine-to-machine (M2M) network domain network service control layer (NSCL). The NSCL comprises a network interface, a memory and a processor. The network interface communicates with external nodes. The memory stores instructions and charging rules. The processor is operatively connected to the network interface and the memory. When instructions stored in the memory are executed by the processor, it determines that an indication of an interaction associated with an M2M device that is received over the network interface is part of a charging event, and in accordance with the charging rules stores in the memory records information associated with charging event in an accessible data repository, and transmits instructions to a third party associated with the M2M device to record information associated with the charging event.

In an embodiment of the present invention, the accessible data repository is the memory. In another embodiment, the accessible data repository is a Charging Data Function accessible to nodes in the M2M network domain. In a further embodiment, the third party is an access network associated with the M2M device. In another embodiment, the third party is a gateway associated with the M2M device.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram illustrating an architecture in which the present invention may be deployed;

FIG. 2 is a block diagram illustrating an architecture in which the present invention may be deployed;

FIG. 3 is a block diagram illustrating an architecture in which the present invention may be deployed;

FIG. 4 is a block diagram illustrating an architecture in which the present invention may be deployed;

FIG. 5 is a block diagram illustrating an architecture in which the present invention may be deployed;

FIG. 6 is a block diagram illustrating a node of the present invention;

FIG. 7 is a flowchart illustrating a method according to an embodiment of the present invention;

FIG. 8 is a flowchart illustrating a method according to an embodiment of the present invention;

FIG. 9 is a flowchart illustrating a method according to an embodiment of the present invention;

FIG. 10 is a flowchart illustrating a method according to an embodiment of the present invention; and

FIG. 11 is a flowchart illustrating a method according to an embodiment of the present invention.

### DETAILED DESCRIPTION

The present invention is directed to a system and method for the generating M2M charging events.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

As noted above, and as used herein, the term charging refers to the functions associated with recording M2M events occurring in a machine-to-machine (M2M) network service control layer (NSCL) and transferring them to charging nodes for billing purposes. Each recorded event can be thought to represent an incoming request to the M2M NSCL and the corresponding response, or an outgoing request and the received response. This allows support for a number of different billing options.

In the following discussion, two planes for capturing M2M events are referenced: the M2M service plane, and the transport plane servicing M2M users and carrying M2M traffic. Capturing events on both planes enables proper identification of events across a number of different network connection topologies related to various business models. It will be apparent to those skilled in the art that when reference is made to different business models, it is equivalent to making reference to network topologies associated with different business arrangements between the network access provider and the M2M service provider. The different business relationships between these two entities result in different network topologies that can render one of the parties blind to events in the other party's domain. The above principles apply to a variety of different transport technologies over which M2M traffic flows; it should not be taken as restrictive to any one networking technology in particular. While M2M events themselves are independent of the access network technology the actual transfer of captured events may require adaptation to the actual access network technology.

For a cellular access network and its corresponding packet core network, there is an existing charging data function (CDF) functionality. Standard CDF functionality is defined in 3GPP TS 32.220 “3rd Generation Partnership Project; Technical Specification Group Services and System Aspects; Telecommunication management; Charging management; Charging Architecture and principles” which is incorporated herein by reference. The conventional CDF functionality can be relied upon as the primary function to receive captured M2M related events at the transport plane. To address events at the M2M service plane, a new functional node herein referred to as the “M2M CDF” is introduced as the M2M service plane analog to the CDF in the transport plane. The M2M NSCL node can communicate with the M2M CDF node to transfer captured M2M events, optionally over the Rf interface, as defined in 3GPP TS 32.299 “3rd Generation Partnership Project; Technical Specification Group Services and System Aspects; Telecommunication management; Charging management; Diameter charging applications”, which is incorporated herein by reference. One skilled in the art will appreciate that the M2M CDF and the corresponding Rf interface need implement only the functions relevant to the M2M service.

The following discussion is a non-limiting illustrative set of examples that can be used to illustrate the charging impacts on various deployment architectures in support of various M2M scenarios. M2M events are shown in some of these exemplary embodiments to be captured in both of the above nodes for business models requiring such a capability.

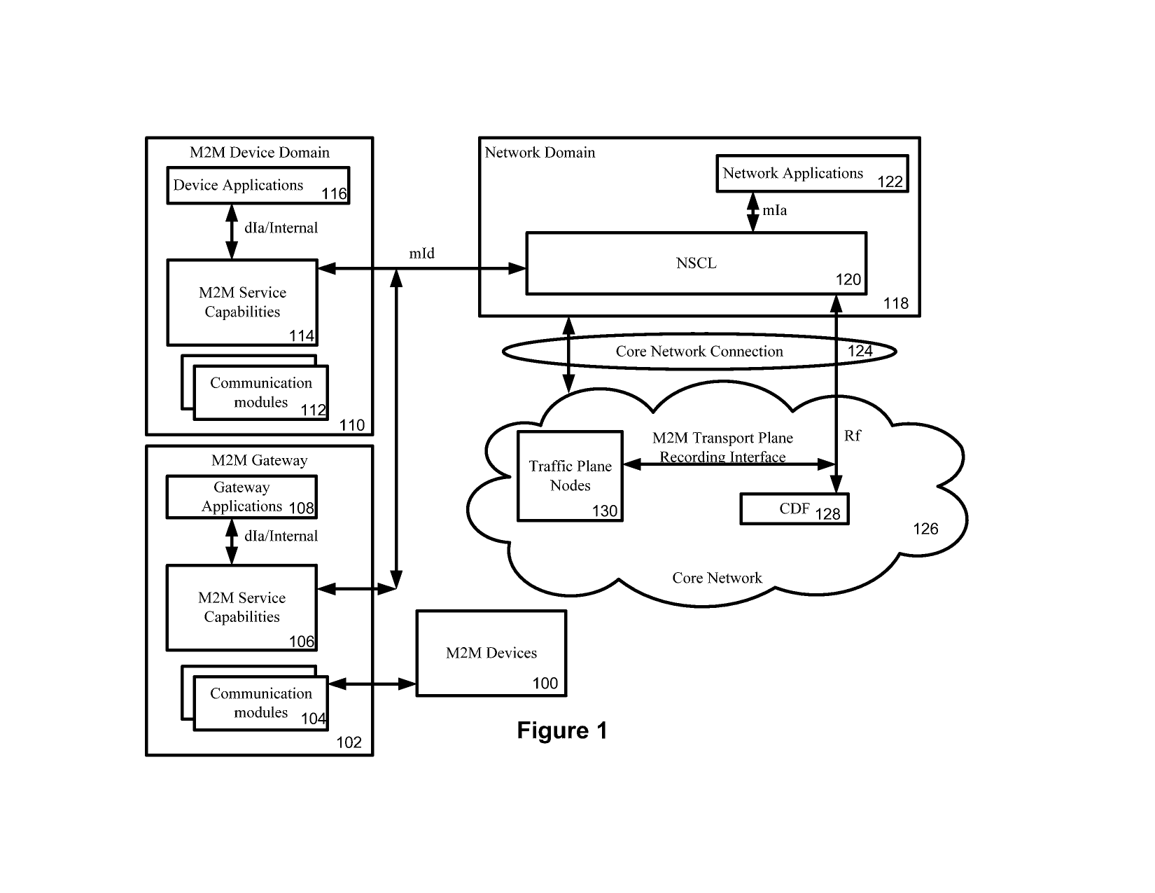

FIG. 1 illustrates a scenario where the access network provider and the M2M service provider are one in the same. This is the first of the business scenarios that is related to a network topology. In such a scenario, both the M2M NSCL service plane node and the pertinent traffic plane nodes, depending on the access network, are used to send M2M event related information, and M2M transport related information respectively to the transport plane CDF using the Rf interface for that purpose. As the M2M NSCL has access to the Access Network Provider's nodes as a result of being the same entity, nodes can be reused by adding the necessary functionality to the existing nodes. Note in this model, the CDF performs the same role as the M2M CDF.

As illustrated in FIG. 1, a M2M device 100 connects with an M2M gateway 102. This connection may be over a radio access network, or over a wired connection depending on the details of implementation. The M2M gateway 102 includes communication modules 104 for communicating with the M2M device 100. Different modules 104 can be provided to allow different connection types. M2M Service Capabilities 106 are used by gateway applcations 108 for connections over an mId interface to an M2M device domain 110 that includes communication modules 112, M2M Service capabilities 114 and Device Applications 116. The mId interface also provides access to the Network domain 118 to both the M2M Device Domain 110 and the M2M Gateway 102. In the Network domain 118, the Network Service Control Layer 120 and network applications 122 communicate over an mIa interface. The Network comain can make use of a core network connection 124 to connect to the M2M Transport Plane 126. The M2M Transport Plane 124 includes traffic plane nodes 130 and the CDF 128. Both Traffic plane nodes 130 and CDF 128 can communicate with the NSCL 120 through Core network OCnnection 124 using an Rf interface.

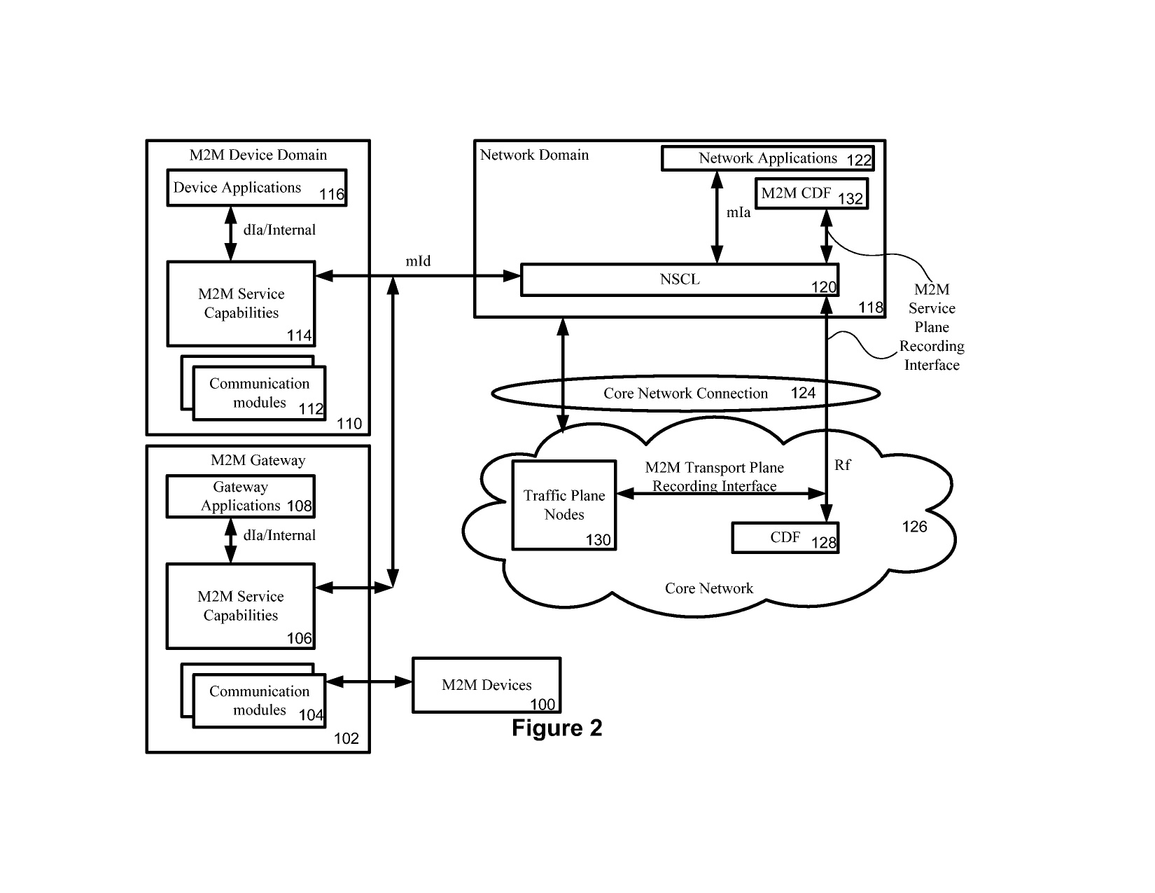

In the scenario where the access network provider and the M2M service provider are distinct, but have a business relationship that allows for sharing of information between their systems, there are two possible scenarios to consider. In the first option, as illustrated in FIG. 2 (which reuses many of the nodes of FIG. 1 which will not be described again in full detail), both the M2M NSCL 120 , and the pertinent traffic plane nodes 130, depending on the access network, can be used to send M2M event related information and M2M transport related information respectively to the CDF 128 using the Rf interface. Furthermore, the M2M NSCL 120 can communicate with the new M2M CDF node 130 to send the same M2M events using a subset of the Rf interface for that purpose. This approach can provide both the access network provider and the M2M SP with the same M2M event related information. In certain embodiments, it may be preferable that implementation of this option be done in conjunction with strong security and authentication mechanisms to ensure that access to the access network provider CDF 128 is well protected and secured.

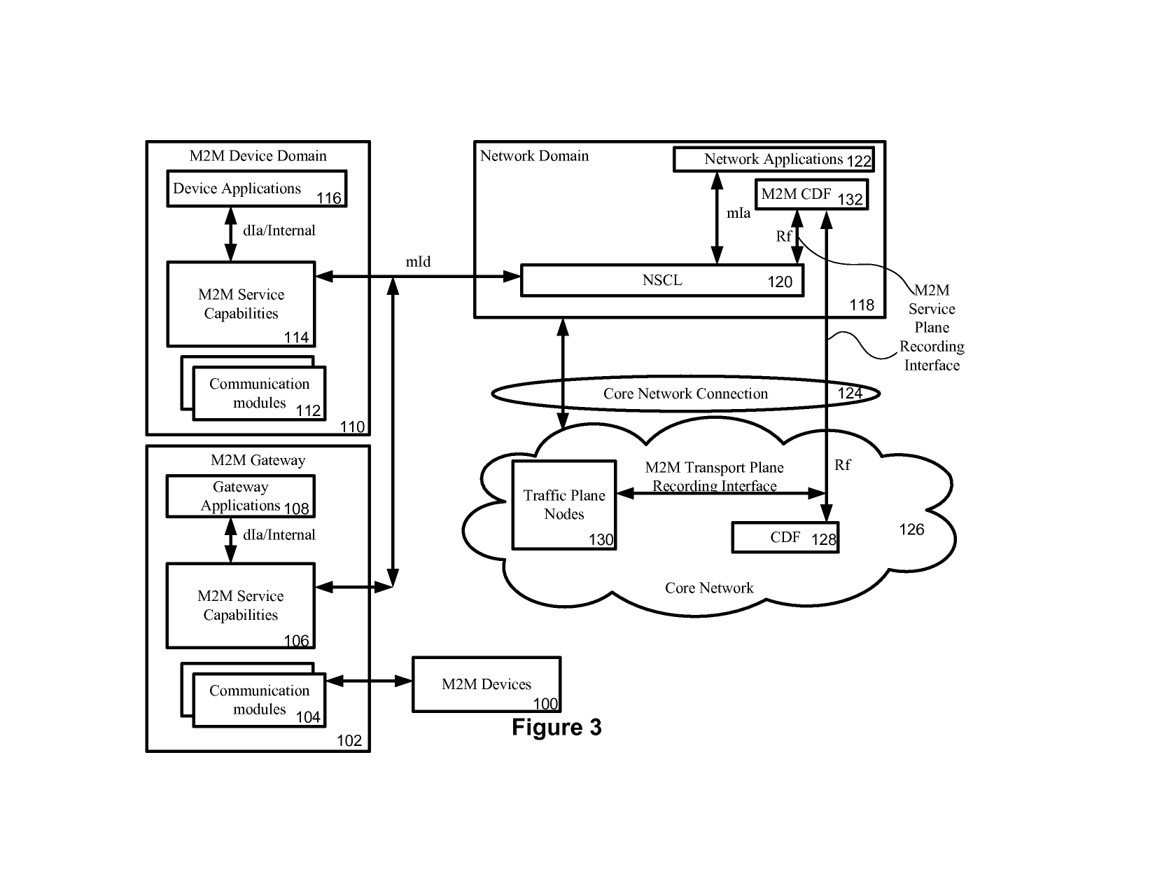

In the second option, as illustrated in FIG. 3, the pertinent traffic plane nodes 130, depending on the access network, send M2M transport related information to the CDF 128 using the Rf interface. The M2M NSCL 120 can communicate with the M2M CDF 132 node using the Rf interface, or a subset thereof Unlike the previous option, the M2M NSCL 120 preferably does not communicate directly with the CDF 128 in the transport plane to relay M2M events. Instead, the M2M CDF 132 can proxy M2M related events it receives from the NSCL 120 to the transport node CDF 128. This relieves the M2M NSCL 120 from that burden. The M2M CDF 132 node can then use the same M2M events for its own purpose as well. As above, in certain embodiments, it may be preferable that the implementation be done in conjunction with strong security and authentication mechanisms to ensure that access to the access network provider CDF 128 is well protected and secured.

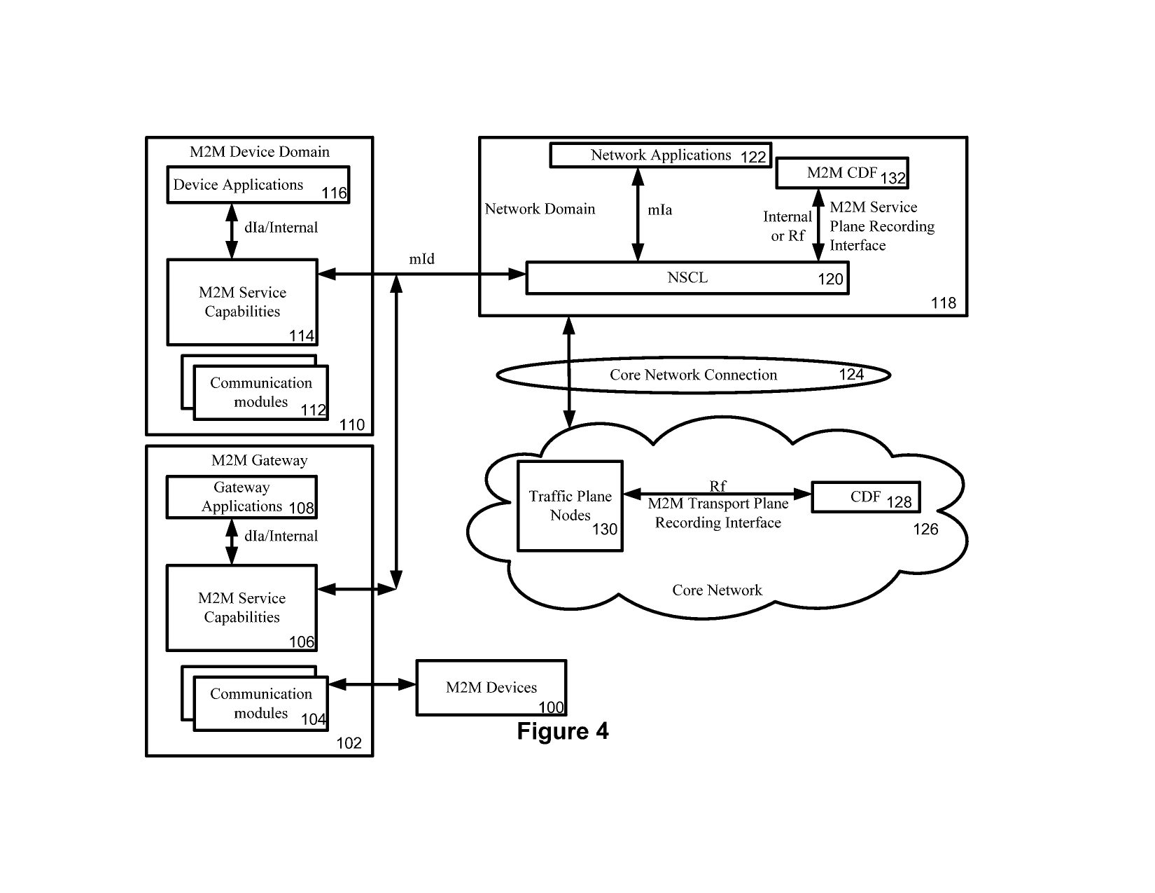

FIG. 4 illustrates a network topology wherein the Access Network Provider does not have a business relation with the M2M Service Provider. In this scenario, the access network provider is a bit pipe and has no real visibility into the operations of the M2M Service Provider. In this case, pertinent traffic plane nodes 130, depending on the access network, can send M2M transport related information to the CDF 128 using the Rf interface if they are able to discern what is being transmitted over the traffic plane. It should be understood that in some implementations it may not be possible for the access network plane to determine what is being sent over the traffic plane, and as such will not be able to initiate recording of events based on the traffic content. The M2M NSCL 120 can communicate with the M2M CDF 132 node using the Rf interface, or a subset thereof where appropriate.

M2M service related information elements refer to the informational elements that are relevant to an M2M service. A listing of M2M Service Plane Information Elements will now be provided with some explanatory information. M2M events sent to the M2M CDF/transport plane CDF can be triggered upon reception by the M2M NSCL of a request and for which the M2M NSCL returned a response, and/or triggered upon a request initiated by the M2M NSCL and for which a response is received. Hence, as noted before, a single M2M event typically represents a request and its response. An M2M event shall include the following elements derived essentially from the request and the response. The following listing of informational elements should not be considered as exhaustive as it can be expanded for extensibility reasons.
M2M Subscription Identifier
Application ID: The Identifier of the application that issued the request (in case that the request is from an application)
Issuer: Issuer of the M2M request (entity representing either an application or an SCL)
Receiver: receiver of an M2M request.
Hosting SCL: The hosting SCL for the request in case the receiver is not the host.
Target ID: The target URL for the M2M request
Resource ID: (this is optional for some primitives)
Primitive Type: Request Type
Protocol Type: HTPP or CoAP
Request Headers size: the number of bytes for the headers in the Request.
Request Body size: the number of bytes of the body transported in the Request.
Response Headers size: the number of bytes for the headers in the Response.
Response Body size: the number of bytes of the body transported in the Response.
Response Code
Response resource result

To enable this information to be carried over the existing Rf interface, the following modifications can be provided in some exemplary embodiments: A new service context can be created for ETSI M2M charging to distinguish a charging message related to an M2M service from others; and A new M2M service element AVP can be required to carry the above information. This new AVP may be included in the accounting request message generated from the M2M NSCL towards the M2M CDF/transport CDF as well as applicable to other accounting messages. One skilled in the art will appreciate that in some embodiments, the M2M event related information is included in this new M2M service element AVP even though some of the values may be identical. The same information is preferably recorded by the M2M NSCL for requests originating from the M2M NSCL towards a gateway or a device or an application and their respective responses. The issuer of the M2M request in this case can include the M2M NSCL-ID, which can be used to distinguish incoming requests to the M2M NSCL from originating requests in recorded information.

The traffic plane nodes may include the new M2M service element AVP, as described above, in accounting requests generated toward the transport plane CDF in conjunction with an ETSI M2M service context. However in such a case, the AVP shall include only the M2M subscription ID element.

The M2M Subscription ID is the M2M informational element that can be used for reconciliation between charging information generated in both planes. This reconciliation can enable support for the various billing models that may be required for the topologies discussed above.

To enable the M2M NSCL to record the necessary information, as described above, in relation to the recorded M2M events, the following associations are preferably maintained by the M2M service provider for all SCL-IDs: the D-SCL-ID for the device and the allocated M2M subscription ID; and the G-SCL-ID for the gateway and the allocated M2M subscription ID. Optionally, if network applications transactions are to be recorded, as well, for charging purposes, one of the following sub-options can also be supported: maintain for all network applications an association, between the NA-ID and the allocated M2M subscription ID to it; or to include the M2M subscription ID allocated to an NA-ID during NA transactions over mIa interface. Those skilled in the art will appreciate that the mIa interface is an interface to allow for applications to access the M2M NSCL. In many preferred embodiments the mIa interface is a restful interface that can be accessed using conventional protocols such as the HyperText Transfer Protocol (http).

For established associations, as described above, the M2M NCL can derive the appropriate M2M subscription ID from the information included in the incoming request to the M2M NCL. This applies to incoming requests over the mId interface and, if applicable, to incoming requests over the mIa interface.

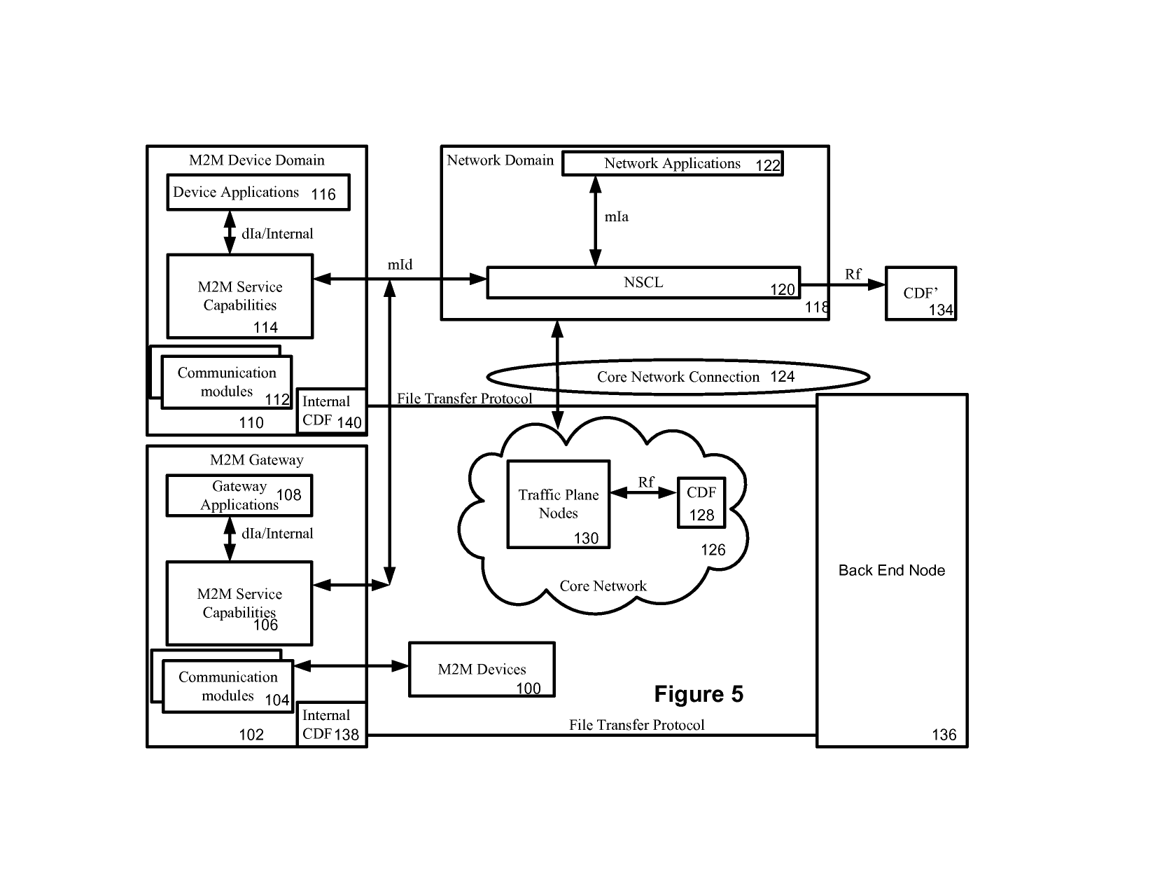

One skilled in the art will appreciate that the various nodes discussed above interact with each other in an ordered and predictable fashion to achieve the results described. The exchange of messages between the nodes can be represented in call flow diagrams and flow charts based on the above descriptions. The following discussion will make use of flow charts that one skilled in the art will appreciate can be rendered as the appropriate call flow diagrams. The nodes themselves can be provided in any of a number of different formats including as general purpose computing nodes such as the one illustrated in FIG. 5. This node has a network interface for receiving messages and data from other nodes, and a processor operatively attached to a memory containing instructions that cause the processor to execute methods allowing the response to and correlation of data as discussed above.

In the M2M NSCL, information is recorded and can then be sent to the CDFs. The recorded information is used to fulfill a variety of different purposes. It will be clear to one skilled in the art that not all of the information recorded across the M2M NSCL plane will be needed for all cases in which some of the information is needed. In such cases, the M2M NSCL can provide only the desired or required information for billing purposes and/or statistical purposes. A separate configuration can be used for each case (i.e. billing and each statistical purpose). Such a configuration can be provided through a filtering capability that allows the M2M NSCL to select only required information in each case. The filtering of information can be applied to M2M NSCL initiated requests as well as M2M NSCL received requests and will preferably provide support for the following capabilities:
Filtering for supported procedures in ETSI M2M (e.g. SCL registration, SCL deregistration, etc.), to be included or excluded. In some embodiments, each supported procedure can be included or excluded, and M2M events related to included procedures are then selected.
For every selected M2M event per the above filtering capability, it can be possible to filter the information within the selected M2M event as well. In one embodiment, all information captured for the filtered M2M event shall be selected for inclusion within the M2M event

Such a multi-hierarchy filtering capability can provide flexibility sufficient to various diverse needs. The above-described filtering capability can be configurable on a per SCL basis as well, using the SCL-ID as will be appreciated by one skilled in the art.

In the billing processes, there may arise a need to classify the recorded M2M events. This can be performed, during the recoding phase, by the M2M NSCL, which can send events to one or both of the M2M CDF and CDF for storage. This classification can serve to allocate a service category to every recorded event. The allocated service category may be a new informational element in addition to what is already provided. A list of exemplary information elements is provided below. The information elements may be typically included in an M2M event identified from at least one of the request and the response.
M2M Subscription Identifier:
Application ID: The Identifier of the application that issued the request (in case that the request is from an application)
Issuer: Issuer of the M2M request (entity representing either an application or an SCL)
Receiver: receiver of an M2M request.
Hosting SCL: The hosting SCL for the request in case the receiver is not the host.
Target ID: The target URL for the M2M request
Resource ID: (this is optional for some primitives)
Primitive Type: Request Type
Protocol Type: HTPP or CoAP
Request Headers size: the number of bytes for the headers in the Request.
Request Body size: the number of bytes of the body transported in the Request.
Response Headers size: the number of bytes for the headers in the Response.
Response Body size: the number of bytes of the body transported in the Response.
Response Code
Response resource result
Service category:
Additional Information: For extensibility reasons

The NSCL can be configured to address implementation specific needs for such information elements. Such a configuration can be selected allow the NSCL to allocate a service category for every recorded M2M procedure. The same service category may be allocated to multiple procedures. The configured service category for an M2M procedure can be included in the recorded information when the M2M event corresponding to the M2M procedure is recorded.

With respect to FIG. 5, the M2M gateway is able to create records on an internal CDF using the same approach depicted above. These records can be made available to the M2M Device domain through the use of a back end node and conventional protocols such as the File Transfer Protocol (FTP). The records can be also made available to both the Core network and the network domain CDF. The transfer of the pertinent records can be managed by the back end node where they can also be used for billing and statistical purposes.

One skilled in the art will appreciate that using the architectures and method disclosed herein, there are a number of relationships and scenarios that can be supported. In some scenarios, such as the one illustrated in FIG. 5, an M2M subscriber can make use a plurality of gateways 102, each of which has a subscription to the M2M Service Provider. This allows an M2M device 100 executing an application 116 to make use of any of the gateways 102 to which it can connect. In such a scenario, the M2M gateway operator can record charging information so that the M2M gateway operator can charge the device owner for the recorded use. Those skilled in the art will appreciate that the M2M gateway internal CDF 138 illustrated in FIG. 5 can be used for this purpose. Note that these devices are typically not visible to the M2M SP.

In a further variant of the above scenario, the M2M service provider could be the owner of the M2M Gateway 102. In either situation, there is a need to distinguish the same application executing on devices connected to multiple M2M Gateways 102 for billing purposes The M2M subscription conventionally is associated with an M2M device 100 or an M2M gateway 102, but it can be expanded to allow for different M2M applications 116 to have different M2M subscriptions so they can be billed separately when executing on multiple M2M gateways 102. To accommodate this, the M2M event recorded data can be expanded to allow for multiple M2M subscriptions (e.g. one for the M2M device 100 or the M2M gateway 102 and one for the M2M applications 116). These subscriptions will preferably be additionally tagged so they can be distinguished when included in the CDR 134 accessible to the NSCL. This way, an M2M application 116 can be distinguished, through its own M2M subscription, for billing purposes, when it is connected to multiple M2M gateways 102. One skilled in the art will appreciate that internal CDF 138 and 140 can communicate with each other through a back end node 136 which makes use of a file transfer protocol (such as ftp) to aid in the movement of data.

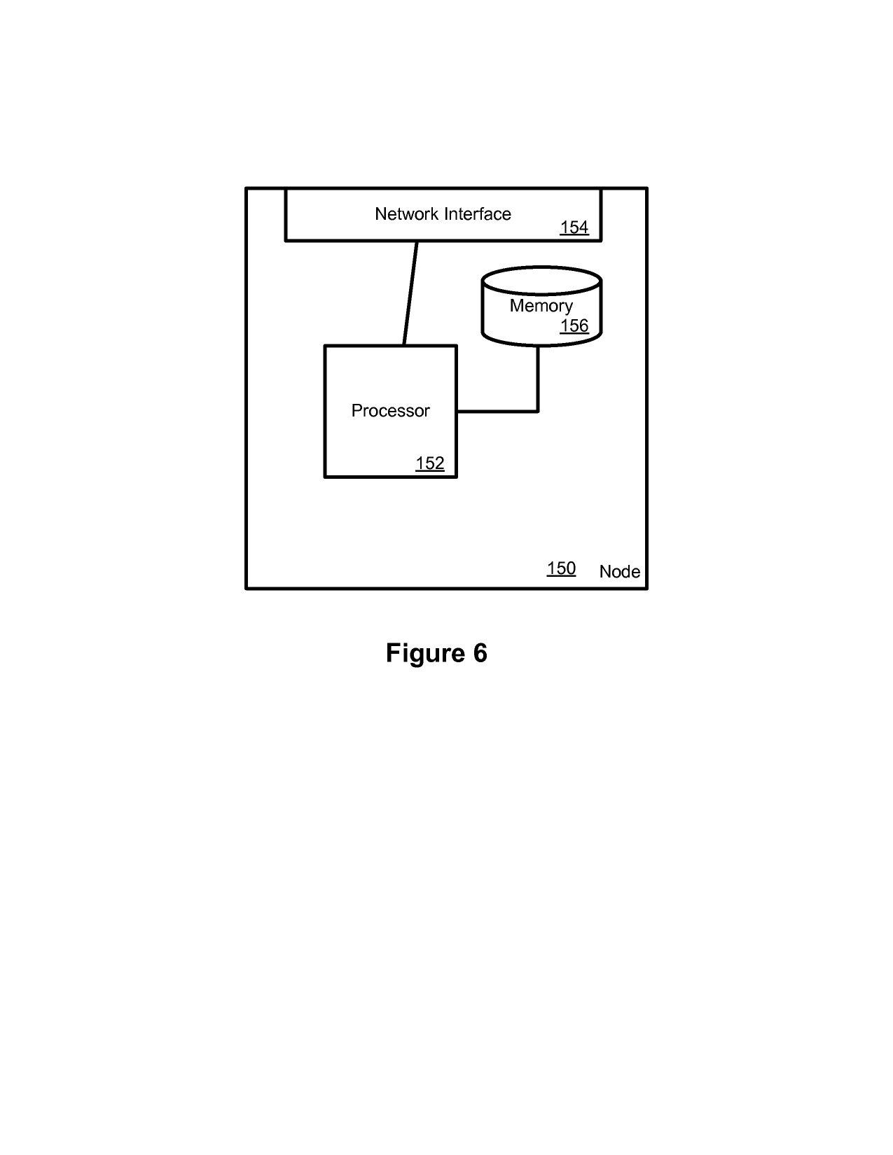

FIG. 6 illustrates an exemplary node 150 of the present invention having a processor 152, a network interface 154 and a memory 156 for storing instructions and other data. The stored instructions when executed on the processor allow the node to carry out the methods described below with respect to the following flowcharts.

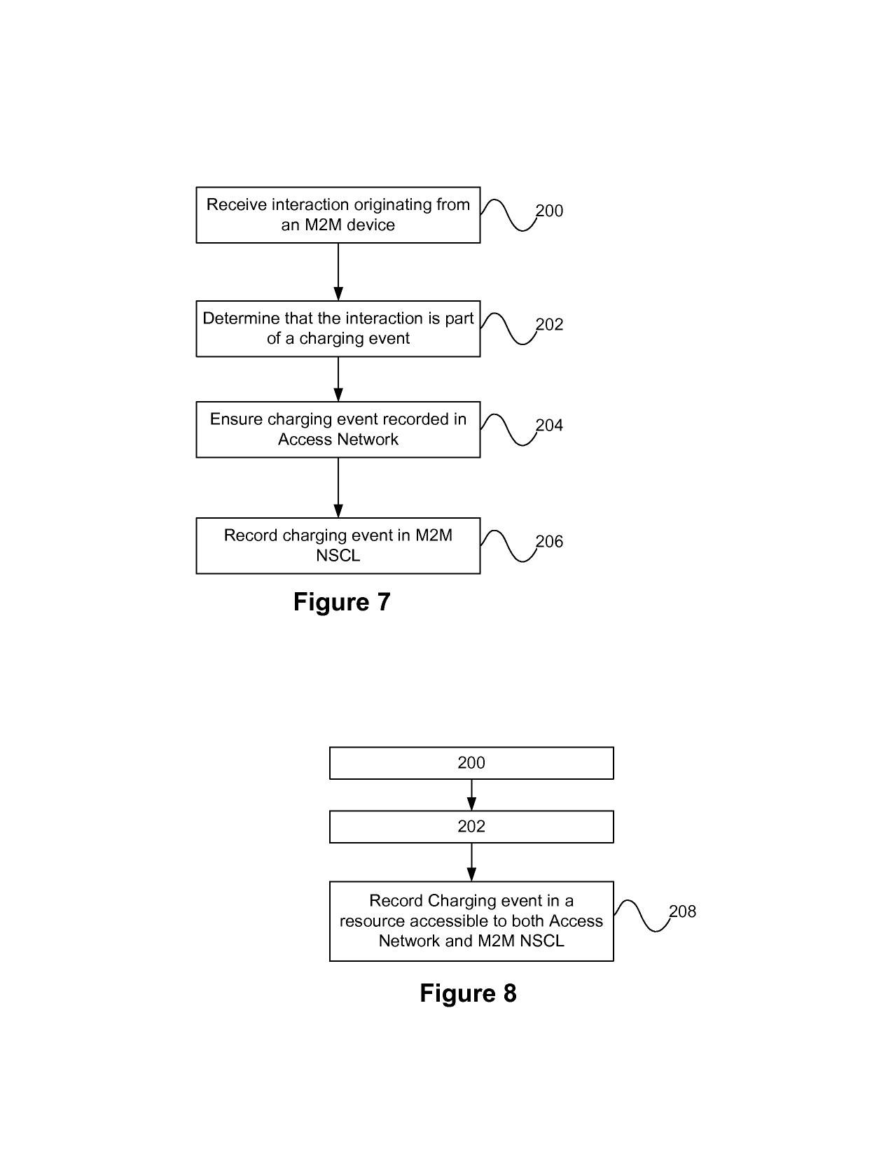

FIG. 7 illustrates an exemplary embodiment of a method of the present invention. As shown in step 200, at the M2M Network Service Control Layer, an interaction (such as a message) is received that originates at an M2M device. The M2M NSCL then determines that the message (the detected interaction) is part of a chargeable M2M transaction. It should be understood that the chargeable nature of the transaction may indicate that the M2M service provider will be charging a M2M subscriber (such as the subscriber associated with the M2M device), or it may indicate that the M2M service provider will be charged by the access network provider. In either event, a charging event is determined to have been started in step 202. Upon making this determination, the M2M NSCL will transmit, to a CDF in a core network associated with the access network used by the M2M device, an instruction to record a charging event associated with the determined transaction. This ensures, in step 204, that the Access Network will have a charging event recorded. In step 206, the M2M NSCL records a chargeable event in a resource accessible to it. By ensuring that there are two matching records of the event, the M2M NSCL creates associated records that can be correlated with each other. This allows for a later reconciliation. In the event that the subscriber is not to be charged, the record accessible to the M2M service plane allows for the charging to be accepted from the Access Network and not forwarded on to the subscriber. Alternatively, where there is no charge from the access network, an event recording the data used is stored by both the access network and the M2M service plane so that correlation can be done at a later point to determine how the subscriber will be charged. The charging event recorded is the NSCL in step 206 can include a set of business rules, or can point to a set of business rules, that will affect how the charging event will be treated.

One skilled in the art will appreciate that the M2M service provider may initiate an event recording in the access network SCL that do not relate directly to charging. Those skilled in the art will appreciate that there may be a need to record events in both systems to allow for statistical analysis at a later date. Although the language of the current discussion centers around the recording of events for charging purposes, it should be understood that the methods and systems of embodiments of the present inventions can also be used to record events that are not charging related.

As shown in FIG. 8, the method of FIG. 7 can be varied. As illustrated, in place of steps 204 and 206, the method can make use of step 208 in which both the M2M charging event and the access network charging event can be stored in the same resource using the same message. Such an embodiment will be understood to be of great value in a system such as that illustrated in FIG. 1, where the M2M service provider and the Access Network provider are one in the same.

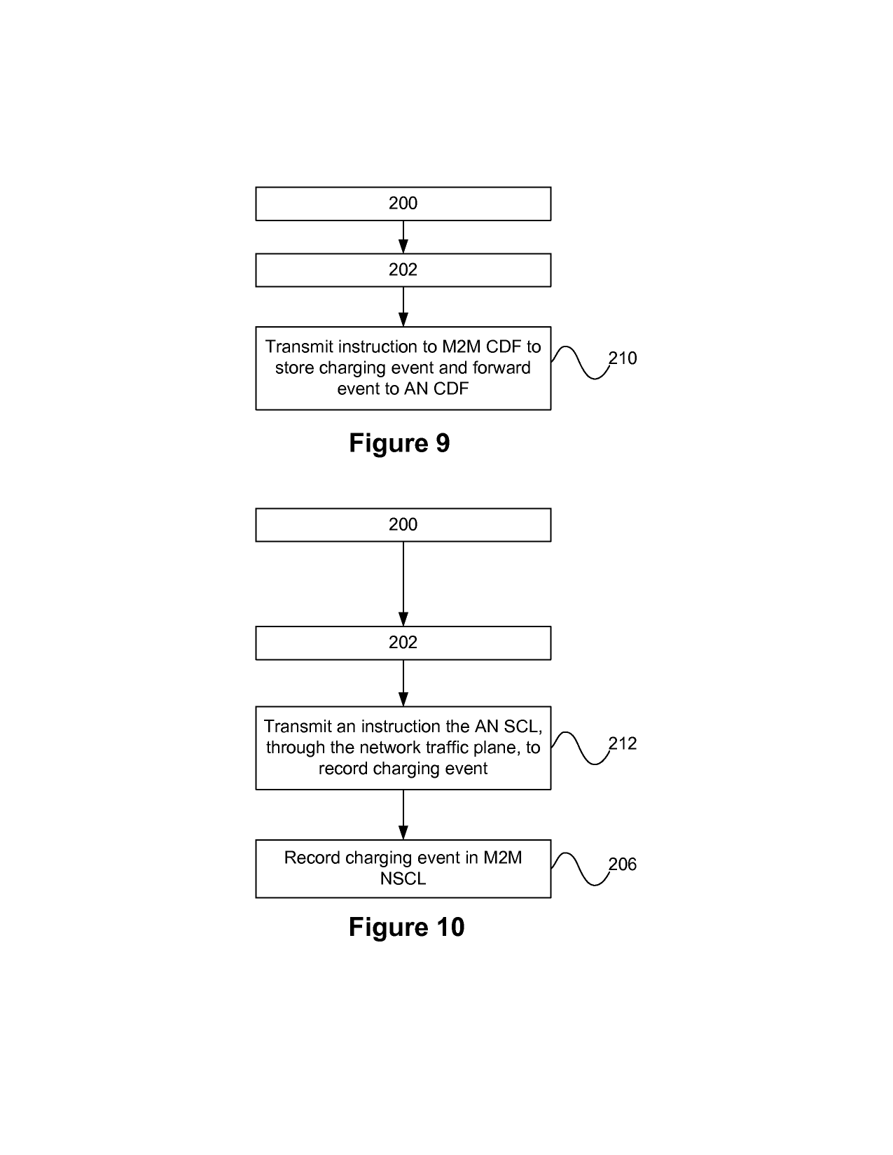

As shown in FIG. 9, the step of transmitting an instruction to record a charging event to the access network CDF can be performed by transmitting a combined instruction to the M2M CDF in step 210, with an indication that the charging event should be stored by the M2M CDF and also forwarded by the M2M CDF to the access network (AN) CDF so that both records can be synchronized.

FIG. 10 illustrates a further alternate method in which the instructions to store the charging event in the AN CDF is transmitted, as shown in step 212, by the M2M NSCL to the AN CDF.

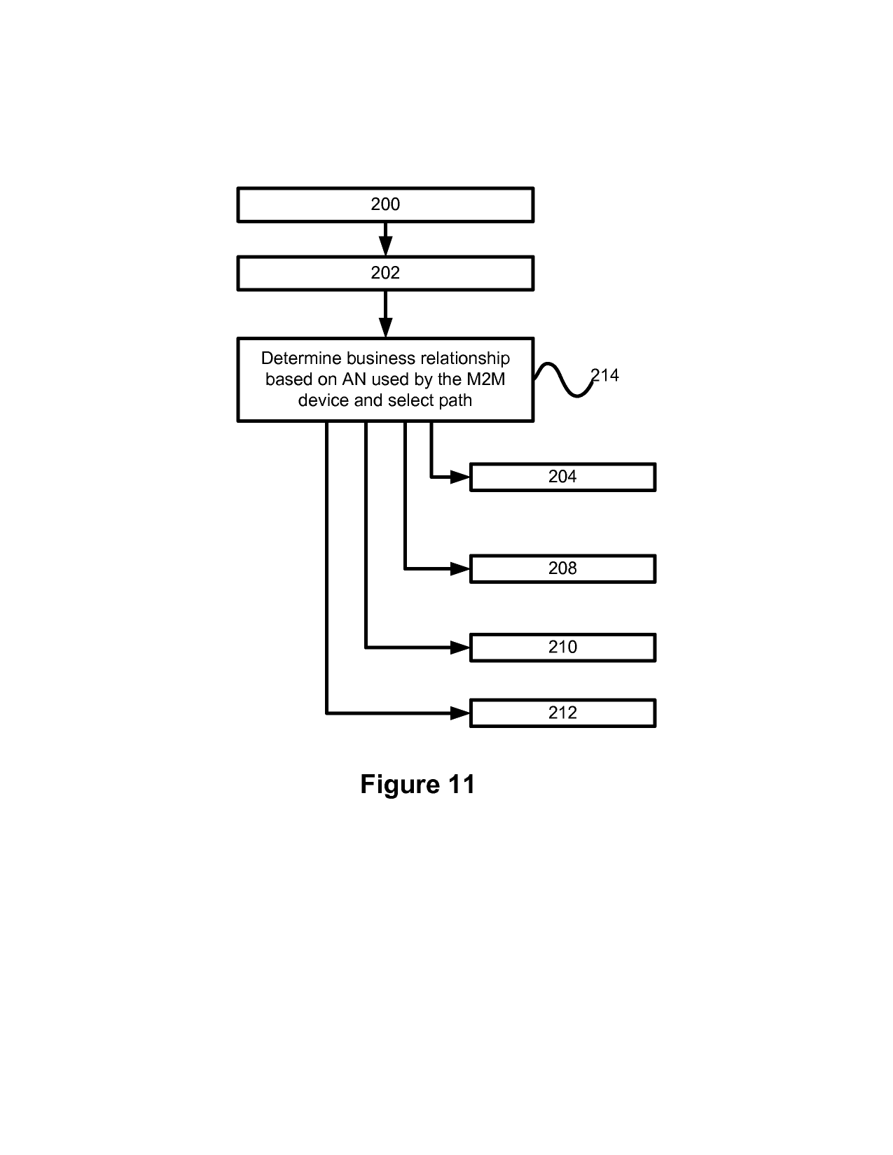

One skilled in the art will appreciate that there can be a number of different business relationships between the access network provider and the M2M SP. In some scenarios, the M2M SP may have different business relationships with different access network providers. In such a scenario, the method of FIG. 11 can be employed. Upon determining that there is a charging event in step 202, the method proceeds to step 214 in which the AN used by the M2M device is used (possibly in conjunction with other factors) to determine which of the business relationships is relevant to the transaction, and thus which step to proceed to. It should be understood that other steps can be appended after the branch so that, for example, following step 204, the process could continue to step 206 as shown in FIG. 7. One skilled in the art will appreciate that this determination of business condition can either be seen as determining the path to take, or can be seen as a factor in determining each step, resulting a flow path similar to that illustrated in FIG. 11.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of storing statistical usage information related to machine-to-machine (M2M) device usage of network resources, for execution by a node in a machine to machine network domain, the method comprising the steps of:
receiving an indication of an interaction associated with an M2M device;
determining that the interaction is part of a charging event;
recording information associated with the charging event in a data repository associated with an M2M network domain Network Service Control Layer (NSCL); and
ensuring that information associated with the charging event is recorded by an a third party associated with the M2M device.

2. The method of claim 1 wherein the receiving the indication includes receiving notification of receipt of one of a message addressed to the M2M device and a message sent by the M2M device.

3. The method of claim 1 wherein the charging event includes an event for which a subscriber account should be adjusted.

4. The method of claim 1 wherein the charging event includes an event for which statistical usage information should be recorded and for which a subscriber account should not be adjusted.

5. The method of claim 1 wherein the third party is an access network is used by the M2M device for access to the M2M network domain.

6. The method of claim 1 wherein ensuring that the charging event is recorded by the third party includes transmitting an instruction to record the event to a service control layer (SCL) in the access network.

7. The method of claim 1 wherein recording the charging event in the M2M network domain NSCL includes transmitting the charging event to a M2M network domain Charging Data Function (CDF).

8. The method of claim 1 wherein the steps of ensuring that the charging event is recorded by the third party and recording the charging event in an M2M domain NSCL are performed by recording the charging event in a resource accessible to both an Access Network and the M2M NSCL.

9. The method of claim 1 wherein the steps of ensuring that the charging event is recorded by the third party and recording the charging event in an M2M domain NSCL are performed by transmitting instructions to a M2M network domain CDF to store information associated with the charging event and to forward information associated with the charging event to an access network associated with the M2M device.

10. The method of claim 9 wherein the instruction to the M2M CDF to forward information directs the M2M CDF to forward information to the access network CDF.

11. The method of claim 1 wherein the step of ensuring includes transmitting an instruction to an access network SCL through the network traffic plane.

12. The method of claim 1 wherein the third party is a gateway connecting the M2M device to the M2M network domain.

13. The method of claim 12 wherein the step of ensuring the charging event is recorded by a third party includes requesting that the gateway store the charging information.

14. The method of claim 13 wherein the step of requesting is done during registration of the gateway to the M2M network domain.

15. The method of claim 1 wherein the recorded information in the data repository associated with the NSCL and the information recorded by the third party is identical.

16. A machine-to-machine (M2M) network domain network service control layer (NSCL) comprising:
a network interface for communicating with external nodes;
a memory for storing instructions and charging rules; and
a processor, operatively connected to the network interface and the memory, which upon executing instructions stored in the memory:
determines that an indication of an interaction associated with an M2M device that is received over the network interface is part of a charging event, and
in accordance with the charging rules stores in the memory records information associated with charging event in an accessible data repository, and transmits instructions to a third party associated with the M2M device to record information associated with the charging event.

17. The NSCL of claim 16 wherein the accessible data repository is the memory.

18. The NSCL of claim 16 wherein the accessible data repository is a Charging Data Function accessible to nodes in the M2M network domain.

19. The NSCL of claim 16 wherein the third party is an access network associated with the M2M device.

20. The NSCL of claim 16 wherein the third party is a gateway associated with the M2M device.
